(19) United States
(12) Patent Application Publication
(10) Pub. No.: US 2008/0218959 A1
(43) Pub. Date: Sep. 11, 2008

(54) Combo internal and external storage system

(76) Inventors: Victor Chuan-Chen Wu, Cupertino, CA (US); Bill Kwong, Saratoga, CA (US)

Correspondence Address: TROXELL LAW OFFICE PLLC;ONE SKYLINE PLACE, SUITE 1404, 5205 LEESBURG PIKE, FALLS CHURCH, VA, 22041, US

(21) Appl. No.: 11/716,036

(22) Filed: Mar. 9, 2007

(51) Int. Cl. G06F 1/16

(52) U.S. Cl. 361/685

(57) ABSTRACT

A combo internal and external storage system which comprising: an enclosure portion, having a plurality of openings on it's real wall and a hollow space for containing the storage device which further comprises a first power interface and a first data interface; and a first PCB, being disposed in the hollow space and further comprising a first connector, a second power interface, a second data interface, a second connector and a power connector; wherein the first connector is used to connect to the first power interface and first data interface of the storage device, the second data interface and second data interface are used to connect to a power interface and data interface of the cradle portion, and the second connector and power connector are used to connect to the computer or equipment by the cable.

### BACKGROUND OF THE INVENTION

1. Field of the Invention

The present invention relates to a combo internal and external storage system that enables a storage device to be conveniently externally connected to a computer or equipment by cables or internally connected to a cradle portion, so as to achieve the goal of external/internal use the storage device.

2. Description of Related Art

A standard desktop computer typically provides one or more compartments (also called drive bays) for the installation of 5¼ inch or 3½ inch storage devices such as CD ROM, DVD ROM or CDRW drive, hard drive, ZIP, SuperDisk etc. Because of space limitation, many desktop computers, Kiosk or computing equipment have only one to two drive bays, thus limiting the number of devices that can be installed. Once a storage device is installed into the drive compartment or drive bay, replacement or upgrade of the storage device requires careful disassembling and reassembling of the computer by a trained technician.

Data storage devices primary fall into two categories: the removable storage and hard disk storage. These two types of data storage devices offer different advantages depending on the type of applications.

In the removable storage, the storage media can be replaced as more storage space is needed. Cost of the media is relatively inexpensive. But the data transfer rate for removable storage devices in general are much slower than hard disk storage. Thus the removable storage is great for data archiving. To access the data stored on a removable storage media, the computer must have a compatible drive that can read the data from the media. Example, a CDRW drive or CD-ROM drive is needed to access the data on a CDRW media, a DVD drive is needed to access data on a DVD media, a 250 MB-ZIP drive is needed to access data on a 250 MB ZIP media. As a result, in order for a computer to access data on a variety of removable media, it must be equipped with various types of drives.

In the case of hard disk storage, the media and the drive are integrated together. With this design, the data transfer rate for hard drive is much faster than the removable storage. Thus hard disk is great for storing program files, for storing data that are accessed all the time and for streaming video application. Since the hard drive and the storage media are all integrated in one unit, the computer can access the data stored in a hard drive by connecting up the hard disk controller cable and the power cable from inside a computer to the hard drive. But this way of connecting a hard drive to a computer usually requires opening up the computer and technical skill.

External hard drive solves the problem of connecting a drive to a computer without opening up the computers. The external hard drives attach to a computer via one of the common I/O ports on a computer: SATA, IDE, SCSI, USB or Firewire interface. Since all the external hard drives are constructed with an enclosure to house the hard drive and the interface electronics. The additional cost of the housing and interface electronics make the external hard drive much more expensive than an internal hard drive and the external hard drive can only be used externally by using cables connecting to the computer. However, the new technology hard disk drive such as SATA hard disk drive has very high transmission speed, such as up to 3 Gb/s, the traditional interface electronics design located in the enclosure will result in degrading the high transmission speed.

Therefore, the solution or invention in this patent deals with a combo internal and external storage system that enables a storage device to be conveniently externally connected to a computer or equipment by cables or internally connected to a computer or equipment via a cradle mounted in the drive bay of the computer or equipment, so as to achieve the maximum data transmission of the storage device In addition, the SATA storage solution as described in this invention also allow the SATA hard drive to perform at equal speed between external and internal connection.

### SUMMARY OF THE INVENTION

The object of the present invention is to provide a combo internal and external storage system that enables a storage device to be conveniently externally connected to a computer or equipment by cables or internally connected to a cradle portion, so as to achieve the goal of externally/internal use the storage device.

According to one non-limited embodiment of the present invention, the combo internal and external storage system comprises: an enclosure portion that can slide in and out of the cradle portion of the computer or equipment, having a plurality of openings on it's real wall and a hollow space for containing the storage device which further comprises a first power interface and a first data interface; and a first PCB, being disposed in the hollow space and further comprising a first connector, a second power interface, a second data interface, a second connector and a power connector; wherein the first connector is used to connect to the first power interface and first data interface of the storage device, the second data interface and second data interface are exposed outward one of the openings and used to connect to a power interface and data interface of the cradle portion, and the second connector and power connector are exposed outward one of the openings and used to connect to the computer or equipment by the cable.

### BRIEF DESCRIPTION OF THE DRAWINGS

The present invention can be more fully understood by reference of the following description and accompanying drawings, in which:

FIG. 1 illustrates a perspective drawing of the enclosure portion of the combo internal and external storage system in accordance with one embodiment of the present invention.

FIG. 2 illustrates the explosion diagram of the first PCB in accordance with one embodiment of the present invention.

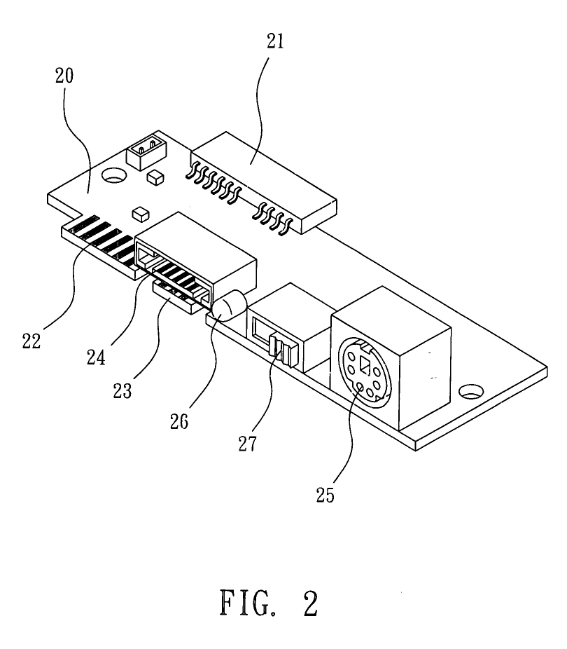

FIG. 3 illustrates the combo internal and external storage system of the present invention is used as an external storage system and connected to a computer or equipment by cables in accordance with one embodiment of the present invention.

FIG. 4 illustrates a perspective drawing of the cradle portion of the combo internal and external storage system in accordance with one embodiment of the present invention.

FIG. 5 illustrates the combo internal and external storage system of the present invention is used as an internal storage system and connected to a computer or equipment in accordance with one embodiment of the present invention.

### DETAILED DESCRIPTION OF THE PREFERRED EMBODIMENTS

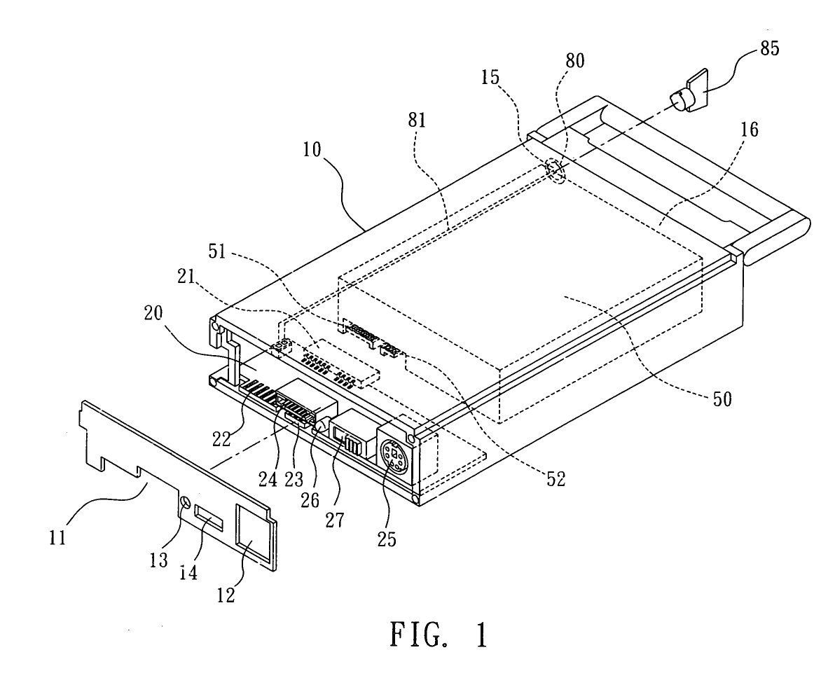

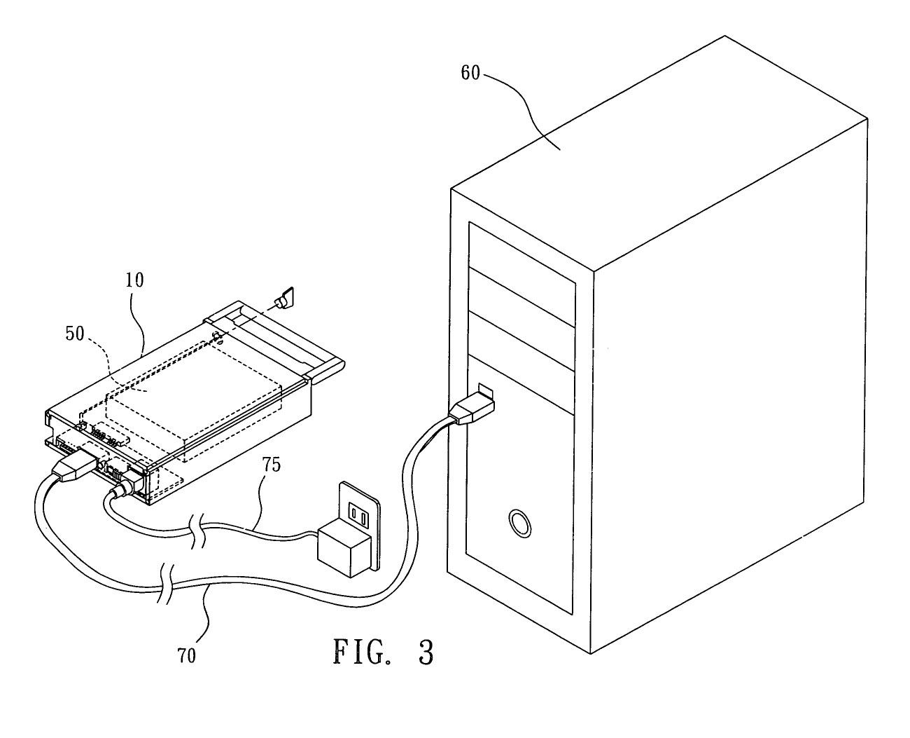

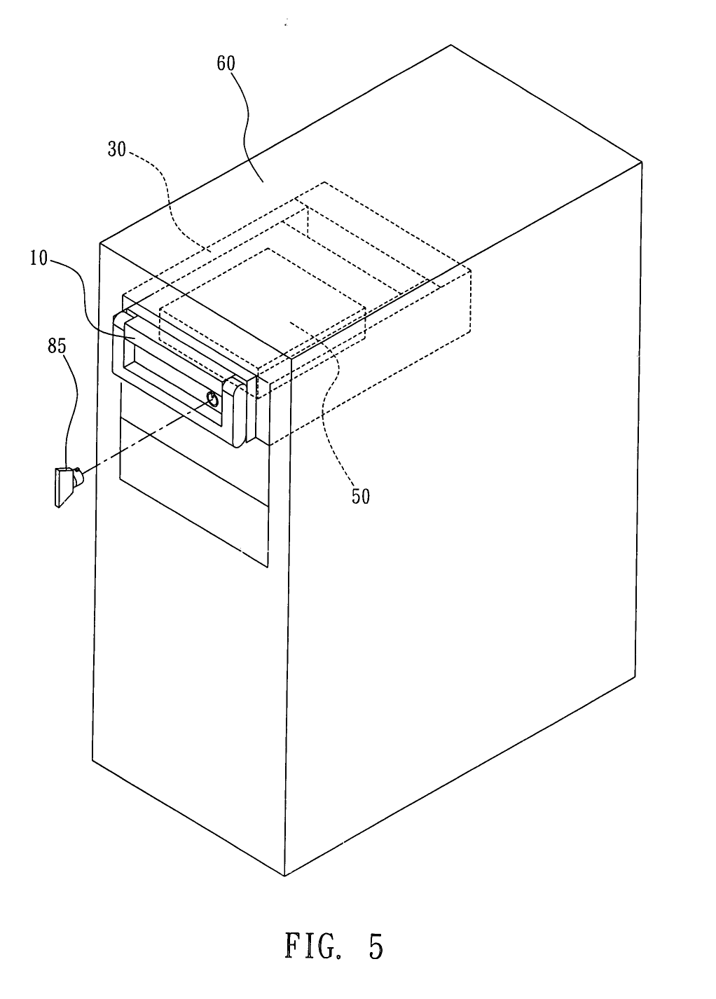

Please refer to FIGS. 1˜3, respectively, the combo internal and external storage system of the present invention can enable different types of storage devices, such as SATA, IDE, SCSI, USB or Firewire type storage devices, to be conveniently externally connected to a computer or equipment by cables or internally connected to a cradle portion, which comprises: an enclosure portion 10; and a first PCB 20. Wherein, the enclosure portion 10 can be connected to a computer or equipment 60 via cables 70,75 (please refer to FIG. 3) or added or removed from a cradle portion 30 of a computer or equipment 60 (please refer to FIG. 5). The cradle portion 30 is designed to have the same width and height of the drive bay of the computer or the equipment so to create a snug fit when the cradle portion 30 (please refer to FIG. 5) is installed inside a standard 5¼ drive bay (not shown in the drawing for simplicity). Once inside the drive bay, the cradle portion 30 is secured to the drive bay on the side by screws, preferably.

Wherein, the enclosure portion 10 that can be slide in and out of the cradle portion 30 of the computer or equipment 60 for containing a storage device 50, such as a hard disk drive. The enclosure portion 10 further comprises a plurality of openings 11˜15 with various shapes and sizes on its real wall and front wall as well as a hollow space 16 for containing the hard disk drive 50. Wherein the storage device 50 is for example but not limited to a SATA, IDE, SCSI, USB or Firewire type hard disk drive (hereinafter referred as a hard disk drive 50); especially, the SATA type hard disk drive is preferably due to its higher transmission speed and less cable size and the hard disk drive 50 further comprises a first power interface 51 and a first data interface 52 for connecting to the enclosure portion 10, wherein the first power interface 51 and first data interface 52 is a gold finger and is a portion of the SATA, IDE, SCSI, USB or Firewire interface the hard disk drive 50, respectively.

The first PCB 20 horizontally disposed in the hollow space 16 and near the rear wall of the enclosure 10 further comprises a first connector 21, a second power interface 22, a second data interface 23, a second connector 24 and a power connector 25.

Wherein the first connector 21 is used to connect to the first power interface 51 and first data interface 52 of the hard disk drive 50, and the first connector 21 is for example but not limited to an IDE, SATA, SCSI, USB or Firewire connector, for the purpose of simply explaining, the embodiment uses the female SATA connector as the first connector 21, but not to limit the scope of the present invention.

The second power interface 22 and second data interface 23 are exposed outward the opening 11 and used to connect to a power interface and data interface of the cradle portion 30, wherein the second power interface 22 and second data interface 23 is a gold finger too, respectively and is a portion of the SATA, IDE, SCSI, USB or Firewire interface, respectively. The second power interface 22 is used to get the power source to the hard disk drive 50, while the second data interface 23 is used to transmit data between the hard disk drive 50 and computer or equipment 60. In the embodiment, the second power interface 22 and second data interface 23 is a portion of a SATA interface, respectively, but not to limit the scope of the present invention.

The second connector 24 is exposed outward the opening 11 and used to connect to the computer or equipment 60 by a SATA cable 70. The second connector 24 is for example but not limited to an IDE, SATA, SCSI, USB or Firewire connector, for the purpose of simply explaining, the embodiment uses the male SATA connector as the second connector 24, but not to limit the scope of the present invention.

The power connector 25 is exposed outward the opening 12 and used to connect to the computer or equipment 60 by the cable 70. Therefore, user can uses a SATA cable 70 to connect the second connector 24 to the I/O port of the computer or equipment 60 and uses a power cable 75 to connect the power connector 25 to the power source so as to use the combo internal and external storage system of the present invention as an external hard disk drive.

Furthermore, the first PCB 20 further comprise an indicator 26 protruded from the opening 13 and disposed on the first PCB 20 for indicating the access status of the hard disk drive 50. Wherein, the indicator 26 is for example but not limited to a LED.

Furthermore, the first PCB 20 further comprise a power switch 27 coupled to the power connector 25 and exposed outward the opening 14 for turning on or off the power source of the storage device 50 when the combo internal and external storage system of the present invention is used as an external storage system.

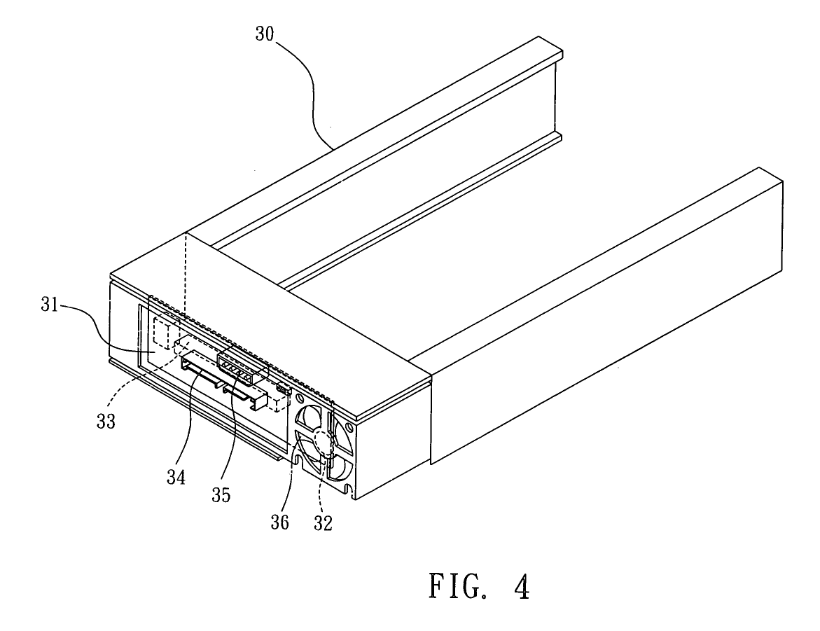

Please refer to FIG. 4, the cradle portion 30 is made of plastic or metal material, such as aluminum, preferably. Furthermore, the cradle portion 30 further comprises a second PCB 31; a fan 32; a third connector 33; a fourth connector 34; and a power second connector 35.

Wherein, the second PCB 31 is for example but not limited to be vertically disposed in the cradle portion 30 and near the rear wall of the cradle portion 30 so as to reduce the required space and transmission path of the SATA data signals and overcome the SATA signals attenuation problem at high speed transmission.

The fan 32 is disposed in the cradle portion 30 and beside the second PCB 31 and coupled to the second PCB 31 to get power source for dissipating heat generated by the hard disk drive 50. Additionally the real wall also has a plurality of round-shaped openings 36 for the fan 32 to dissipate heat easily.

The third connector 33 is disposed on the second PCB 31 for being connected to the second power interface 22 and second data interface 23 of the first PCB 20. The third connector 33 is for example but not limited to an IDE, SATA, SCSI, USB or Firewire connector, for the purpose of simply explaining, the embodiment uses the female SATA connector as the third connector 33, but not to limit the scope of the present invention.

The fourth connector 34 is disposed on the second PCB 31 and oppositely against the third connector 33 for being connected to a data socket of a mother board (not shown) of the computer or equipment 60. The fourth connector 34 is for example but not limited to an IDE, SATA, SCSI, USB or Firewire connector, for the purpose of simply explaining, the embodiment uses the male SATA connector as the fourth connector 34, but not to limit the scope of the present invention.

The power second connector 35 is disposed in the second PCB 31 and oppositely against the third connector 33, above the fourth connector 34 is preferably, for being connected to a power socket of a mother board (not shown) of the computer or equipment 60.

Please refer to FIG. 5, the combo internal and external storage system of the present invention further comprises a lock seat 80 protruded from the opening 15 and coupled to the first PCB 20 through wires 81; whereby a key 85 can be inserted into the lock seat 80 for turning on or off the power source of the hard disk drive 50.

Therefore, the present invention is to provide a combo internal and external storage system that enables a storage device to be conveniently external connected to a computer or equipment by cables or internal connected to a cradle portion, so as to achieve the goal of external/internal use the storage device.

While the invention has been disclosed with reference to preferred embodiments thereof, it is to be understood that modifications or variations may be easily made without departing from the spirit of this invention, which is defined in the appended claims.

What is claimed is:

1. A combo internal and external storage system that enables a storage device to be conveniently externally connected to a computer or equipment by a cable or internally connected to a cradle portion, which comprising:
an enclosure portion that can be slide in and out of said cradle portion of said computer or equipment, having a plurality of openings on it's real wall and a hollow space for containing said storage device which further comprises a first power interface and a first data interface; and
a first PCB, being disposed in said hollow space and further comprising a first connector, a second power interface, a second data interface, a second connector and a power connector; wherein said first connector is used to connect to said first power interface and first data interface of said storage device, said second data interface and second data interface are exposed outward one of said openings and used to connect to a power interface and data interface of said cradle portion, and said second connector and power connector are exposed outward one of said openings and used to connect to said computer or equipment by said cable.

2. The combo internal and external storage system according to claim 1, wherein said cradle portion can be secured to a drive bay of the computer or equipment and has outside dimension equal the inside dimension of said drive bay is mounted permanently inside a 5¼ drive bay.

3. The combo internal and external storage system according to claim 1, wherein said storage device is a hard disk drive with a SATA, IDE, SCSI, USB or Firewire interface.

4. The combo internal and external storage system according to claim 3, wherein said first power interface and first data interface is a gold finger, respectively and is a portion of said SATA, IDE, SCSI, USB or Firewire interface, respectively.

5. The combo internal and external storage system according to claim 1, wherein said first connector is an IDE, SATA, SCSI, USB or Firewire connector.

6. The combo internal and external storage system according to claim 1, wherein said second power interface and second data interface is a gold finger, respectively and is a portion of said SATA, IDE, SCSI, USB or Firewire interface, respectively.

7. The combo internal and external storage system according to claim 1, wherein said second connector is a SATA, IDE, SCSI, USB or Firewire connector.

8. The combo internal and external storage system according to claim 1, wherein said first PCB further comprises a power switch coupled to said power connector and exposed outward one of said openings.

9. The combo internal and external storage system according to claim 1, wherein said cradle portion further comprising:
a second PCB, being disposed in said cradle portion;
a fan, being coupled to said second PCB to get power for dissipating heat;
a third connector, being disposed on said second PCB for being connected to said second power interface and second data interface of said first PCB;
a fourth connector, being disposed on said second PCB and oppositely against said third connector for being connected to a data socket of a mother board of said computer or equipment; and
a power second connector, being disposed in said second PCB and oppositely against said third connector for being connected to a power socket of a mother board of said computer or equipment.

10. The combo internal and external storage system according to claim 9, wherein it further comprises a lock seat protruded from one opening of a front wall of said enclosure portion and coupled to said first PCB through wires; whereby a key can be inserted into said lock seat for controlling said storage device whether to be turned on or not.

11. The combo internal and external storage system according to claim 10, wherein it further comprise a indicator protruded from one of said openings and disposed on said first PCB for indicating the access status of said storage device.

12. The combo internal and external storage system according to claim 9, wherein said third connector and fourth connector is a SATA, IDE, SCSI, USB or Firewire connector, respectively and being disposed oppositely.
